(19) United States
(12) Patent Application Publication
(10) Pub. No.: US 2012/0139946 A1
(43) Pub. Date: Jun. 7, 2012

(54) SYSTEM AND METHOD FOR ADJUSTING DISPLAY OF COMPUTER MONITOR

(75) Inventors: XIN-QIAO TANG, Shenzhen City (CN); YANG ZHONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/278,189

(22) Filed: Oct. 21, 2011

(30) Foreign Application Priority Data
Dec. 2, 2010 (CN) 201010570342.9

(51) Int. Cl. G09G 5/00

(52) U.S. Cl. 345/660

(57) ABSTRACT

In a method for adjusting a display of a computer monitor, the computer monitor includes a storage system storing display parameters of the computer monitor and an on-screen display (OSD) menu. A size proportion of a display screen of the computer monitor and a virtual region on the display screen is defined, and a functional relationship between virtual parameters and the display parameters is predetermined. The OSD menu acquires the display parameters that are user-adjustable, and updates the display parameters in the storage system. The virtual parameters corresponding to the display parameters are computed according to the functional relationship. The computer monitor displays data output from a host computer on the virtual region according to the computed virtual parameters.

### BACKGROUND

1. Technical Field

Embodiments of the present disclosure relate generally to computer monitor adjustment, and more particularly, to a system and method for adjusting display of a computer monitor.

2. Description of Related Art

After a video card of a host computer is replaced, a display of a computer monitor that connects to the host computer may be distorted. For example, boundaries of the display may not be shown in a display screen of the computer monitor due to unexpected reasons, such as display resolution of the computer monitor is not an appropriate resolution for the computer monitor. It is inconvenient to adjust the display when users can not observe the boundaries of the display. What is needed, therefore, is a method for adjusting the display of the computer monitor to overcome the limitations described.

### BRIEF DESCRIPTION OF THE DRAWINGS

FIG. 1 is a block diagram of one embodiment of a computer monitor including a display adjustment system.

FIG. 2A is a schematic diagram of display with a full screen on a display screen of the computer monitor, and FIG. 2B is a schematic diagram of the display on a virtual region of the display screen.

FIG. 3 is a block diagram of functional modules of the display adjustment system included in the computer monitor of FIG. 1.

FIG. 4 is a flowchart of one embodiment of a method for adjusting display of the computer monitor of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

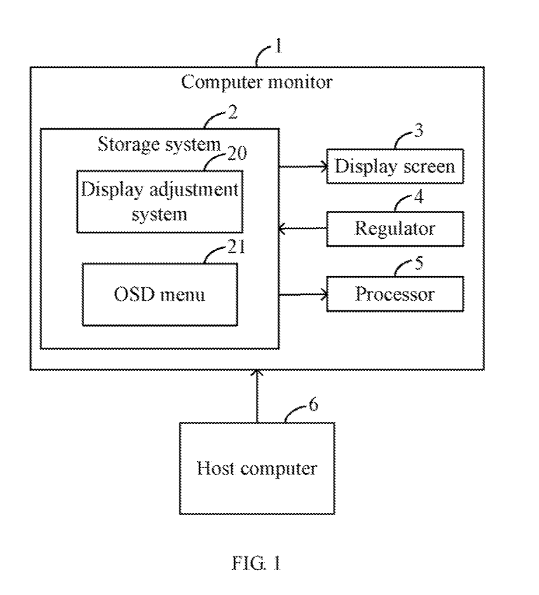

FIG. 1 is a block diagram of one embodiment of a computer monitor 1 including a display adjustment system 20. Depending on the embodiment, the computer monitor 1 connects to a host computer 6 that can output data, such as pictures and videos, to the computer monitor 1. In the embodiment, the computer monitor 1 includes a storage system 2, a display screen 3, a regulator 4, and at least one processor 5. It should be apparent that FIG. 1 is just one example of the computer monitor 1 that can be included with more or fewer components than shown in other embodiments, or a different configuration of the various components.

The display adjustment system 20 may be in the form of one or more programs that stored in the storage system 2 and executed by the at least one processor 5. In one embodiment, the storage system 2 may be random access memory (RAM) for temporary storage of information, and/or a read only memory (ROM) for permanent storage of information. In other embodiments, the storage system 2 may also be an external storage device, such as a hard disk, a storage card, or a data storage medium. The at least one processor 5 executes computerized operations of the computer monitor 1 and other applications, to provide functions of the computer monitor 1.

The storage system 2 stores computerized code for an on-screen display (OSD) menu 21 and a plurality of display parameters of the computer monitor 1. The OSD menu 21 is operable to display several options on the display screen 3 that are user-adjustable to adjust the display parameters of the computer monitor 1 on the display screen 3. The display parameters, such as display resolution, contrast ratio, and display position, are stored in the storage system 2. The users can adjust the display parameters using the regulator 4. In one embodiment, the regulator 4 may be a group of buttons or knobs. For example, the users can reduce a value of the contrast ratio from thirty to twenty by pressing the regulator 4. The OSD menu 21 is further operable to acquire the adjusted display parameters, and update the display parameters in the storage system 2. The computer monitor 1 displays the output data received from the host computer 6 according to the display parameters stored in the storage system 2.

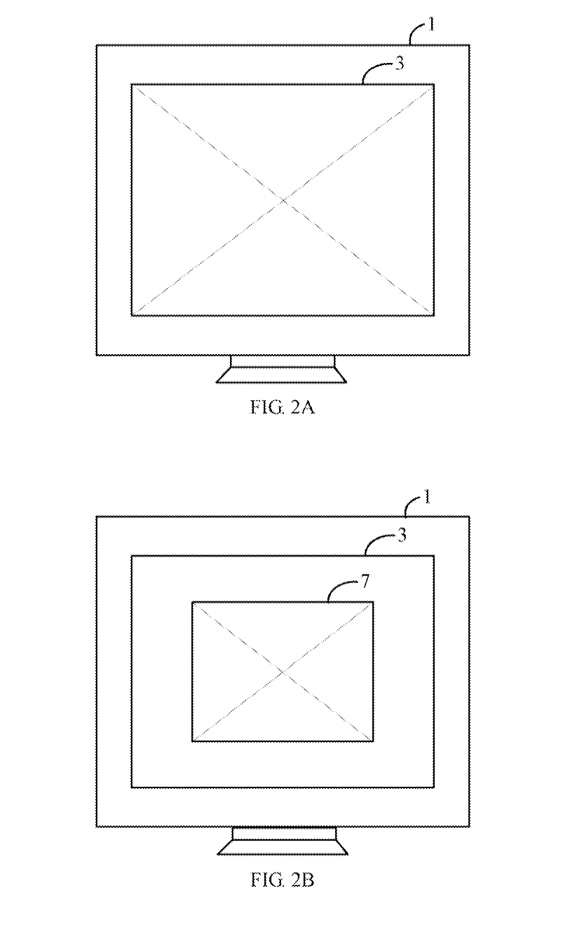

Usually, the computer monitor 1 displays the output data full screen on the display screen 3, such that the output data occupies a region “x” as shown in FIG. 2A. In one embodiment, the display adjustment system 20 may control the computer monitor 1 to display the output data on a virtual region of the display screen 3 when the display parameters are being adjusted. Referring to FIG. 2B, a size proportion of the virtual region 7 and the display screen 3 is fixed, such as the size of the virtual region 7 is just two-thirds of the size of the display screen 3. In the embodiment, the virtual region 7 is located in the center of the display screen 3, such that the virtual region 7 occupies a region “x” as shown in FIG. 2B. The computer monitor 1 can display the output data on the virtual region 7 as the display parameters are being adjusted using the OSD menu 21. In this method, the users can observe boundaries of the display of the computer monitor 1, even if the boundaries of the display is not shown in the virtual region 7.

The computer monitor 1 displays the output data full screen on the display screen 3 according to the display parameters. If the display adjustment system 20 controls the computer monitor 1 to display the output data on the virtual region 7, the computer monitor 1 may display the output data according to a plurality of virtual parameters. The virtual parameters may also include display resolution, contrast ratio, and display position. Each of the virtual parameters and corresponding to one of the display parameters has a functional relationship. The functional relationship can be determined by experimentation according to the size proportion of the virtual region 7 and the display screen 3. For example, if the size proportion of the virtual region 7 and the display screen 3 is 1:3, the functional relationship may include that contrast ratio value of the virtual parameters is one fourth of the contrast ratio value of the display parameters. Because of the functional relationship, the display of the output data on the virtual region 7 has the same effect with the display of the output data on the full screen of the display screen 3. In one example, if the display of the output data with the full screen has a trapezoidal distortion, the display of the output data on the virtual region 7 has the same trapezoidal distortion.

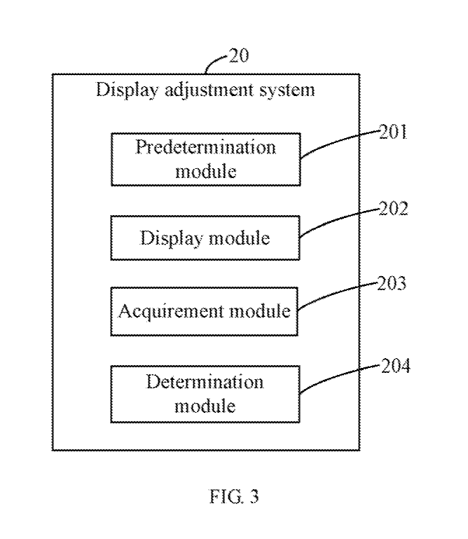

FIG. 3 is a block diagram of functional modules of the display adjustment system 20 included in the compute monitor 1 of FIG. 1. In one embodiment, the display adjustment system 20 may include a predetermination module 201, a display module 202, an acquirement module 203, and a determination module 204. The modules 201-204 may comprise a plurality of functional modules each comprising one or more programs or computerized codes that can be accessed and executed by the at least one processor 5. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives

The predetermination module 201 is operable to define the size proportion of the virtual region 7 and the display screen 3, and predetermine the functional relationship between the virtual parameters and the display parameters. The functional relationship can be determined by experimentation according to the size proportion.

The display module 202 is operable to generate a striking box in the center of the display screen 3 according to the size proportion in response to start of the OSD menu 21, and display the virtual region 7 in the striking box of the display screen 3. The striking box is a virtual box having four sides with a striking color, such as red. As shown in FIG. 2B, the virtual region 7 is in the striking box displayed on the display screen 3, and the four sides of the striking box are boundaries of the virtual region 7.

The OSD menu 21 acquires one or more display parameters adjusted by a user, and updates the display parameters stored in the storage system 2 with the adjusted display parameters. The acquirement module 203 is operable to acquire the display parameters from the storage system 2, and compute the virtual parameters corresponding to the display parameters according to the functional relationship all the time.

The display module 202 is further operable to display data output from the host computer 6 on the virtual region 7 according to the computed virtual parameters.

The determination module 204 is operable to determine whether the OSD menu 21 is closed for stopping adjusting the display of the computer monitor 1.

The display module 202 is further operable to display the output data full screen on the display screen 3 according to the display parameters, and hide the virtual region 7 from the display screen 3 in response to close of the OSD menu 21.

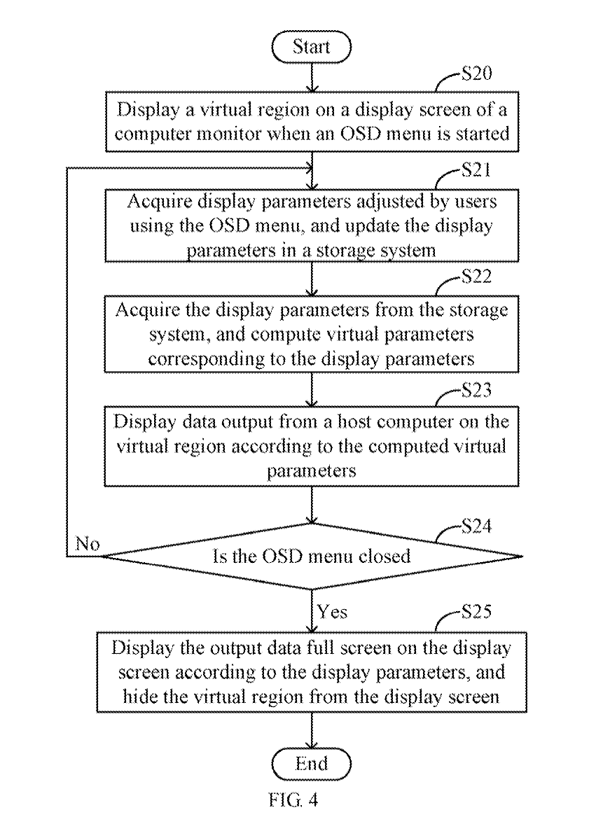

FIG. 4 is a flowchart of one embodiment of a method for adjusting display of the computer monitor 1 of FIG. 1. Depending on the embodiment, additional blocks may be added, others removed, and the ordering of the blocks may be changed. Before block S20, the predetermination module 201 defines a size proportion of the virtual region 7 and the display screen 3, and predetermines a functional relationship between the virtual parameters and the display parameters. The functional relationship can be determined by experimentation according to the size proportion.

In block S20, the display module 202 generates a striking box in the center of the display screen 3 according to the size proportion in response to start of the OSD menu 21, and displays the virtual region 7 in the striking box of the display screen 3. The striking box is a virtual box having four sides with a striking color, such as red. As shown in FIG. 2B, the virtual region 7 is in the striking box displayed on the display screen 3, and the four sides of the striking box are the boundaries of the virtual region 7.

In block S21, the OSD menu 21 acquires one or more display parameters adjusted by a user, and updates the display parameters in the storage system 2 with the adjusted display parameters. In one embodiment, the display parameters may include display resolution, contrast ratio, and display position.

In block S22, the acquirement module 203 acquires the display parameters from the storage system 2, and computes the virtual parameters corresponding to the display parameters according to the functional relationship.

In block S23, the display module 202 displays data output from the host computer 6 on the virtual region 7 according to the computed virtual parameters.

In block S24, the determination module 204 determines whether the OSD menu 21 is closed. If the OSD menu 21 is closed, block S25 is implemented. If the OSD menu 21 is not closed, block S21 is implemented.

In block S25, the display module 202 displays the output data full screen on the display screen 3 according to the display parameters, and hides the virtual region 7 from the display screen 3.

All of the processes described above may be embodied in, and fully automated via, functional code modules executed by one or more general purpose processors of the computing devices. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer monitor, comprising:
a display screen;
a storage system that stores an on-display screen (OSD) menu and a plurality of display parameters of the computer monitor;
at least one processor; and
one or more programs stored in the storage system and executable by the at least one processor, the one or more programs comprising:
a predetermination module operable to define a size proportion of the display screen and a virtual region on the display screen, and predetermine a functional relationship between the display parameters and virtual parameters that enable the computer monitor to display data output from a host computer on the virtual region;
a display module operable to display the virtual region on the display screen according to the size proportion in response to start of the OSD menu;
an acquirement module operable to acquire the display parameters from the storage system, and compute the virtual parameters corresponding to the display parameters according to the functional relationship;
the display module further operable to display the output data on the virtual region according to the computed virtual parameters, and display the output data full screen on the display screen according to the display parameters in response to close of the OSD menu.

2. The computer monitor of claim 1, wherein the display module is further operable to hide the virtual region from the display screen in response to close of the OSD menu.

3. The computer monitor of claim 1, wherein the functional relationship between the display parameters and the virtual parameters is determined by experimentation according to the size proportion.

4. The computer monitor of claim 1, wherein the virtual region displays in a striking box in the center of the display screen.

5. The computer monitor of claim 1, wherein the OSD menu acquires the display parameters that are user-adjustable, and updates the display parameters stored in the storage system with the user-adjustable display parameters.

6. A method for adjusting display of computer monitor, the computer monitor comprising a display screen and a storage system that stores an on-screen display (OSD) menu and a plurality of display parameters of the computer monitor, the method comprising:
(a) defining a size proportion of the display screen and a virtual region on the display screen, and predetermining a functional relationship between the display parameters and virtual parameters that enable the computer monitor to display data output from a host computer on the virtual region;
(b) displaying the virtual region on the display screen according to the size proportion in response to start of the OSD menu;
(c) acquiring the display parameters from the storage system, and computing the virtual parameters corresponding to the display parameters according to the functional relationship;
(d) displaying the output data on the virtual region according to the computed virtual parameters; and
(e) displaying the output data full screen on the display screen according to the display parameters in response to close of the OSD menu.

7. The method of claim 6, wherein the block (e) further comprises:
hiding the virtual region from the display screen in response to close of the OSD menu.

8. The method of claim 6, wherein the functional relationship between the display parameters and the virtual parameters is determined by experimentation according to the size proportion.

9. The method of claim 6, wherein the virtual region displays in a striking box in the center of the display screen.

10. The method of claim 6, wherein the OSD menu acquires the display parameters that are user-adjustable, and updates the display parameters stored in the storage system with the user-adjustable display parameters.

11. A non-transitory storage medium storing a set of instructions, the set of instructions capable of being executed by a processor of a computer monitor, causes the computer monitor to execute a method for adjusting a display of the computer monitor, the computer monitor comprising a display screen and a storage system that stores an on-screen display (OSD) menu and a plurality of display parameters of the computer monitor, the method comprising:
(a) defining a size proportion of the display screen and a virtual region on the display screen, and predetermining a functional relationship between the display parameters and virtual parameters that enable the computer monitor to display data output from a host computer on the virtual region;
(b) displaying the virtual region on the display screen according to the size proportion in response to start of the OSD menu;
(c) acquiring the display parameters from the storage system, and computing the virtual parameters corresponding to the display parameters according to the functional relationship;
(d) displaying the output data on the virtual region according to the computed virtual parameters; and
(e) displaying the output data full screen on the display screen according to the display parameters in response to close of the OSD menu.

12. The medium of claim 11, wherein the block (e) further comprises:
hiding the virtual region from the display screen in response to close of the OSD menu.

13. The medium of claim 11, wherein the functional relationship between the display parameters and the virtual parameters is determined by experimentation according to the size proportion.

14. The medium of claim 11, wherein the virtual region displays in a striking box in the center of the display screen.

15. The medium of claim 11, wherein the OSD menu acquires the display parameters that are user-adjustable, and updates the display parameters stored in the storage system with the user-adjustable display parameters.
